(19) United States
(12) Patent Application Publication
(10) Pub. No.: US 2011/0107291 A1
(43) Pub. Date: May 5, 2011

(54) DESIGN SYSTEM AND METHOD THAT, DURING TIMING ANALYSIS, COMPENSATES FOR REGIONAL TIMING VARIATIONS

(75) Inventors: John E. Barwin, Essex Junction, VT (US); Nazmul Habib, South Burlington, VT (US); Manikandan Viswanath, South Burlington, VT (US)

(73) Assignee: International Business Machines Corporation, Amonk, NY (US)

(21) Appl. No.: 12/612,909

(22) Filed: Nov. 5, 2009

(51) Int. Cl. G06F 17/50

(52) U.S. Cl. 716/134; 716/108; 716/118; 716/126

(57) ABSTRACT

Disclosed are embodiments that allow for compensation of regional timing variations during timing analysis and, optionally, allow for optimize placement of critical paths, as a function of such regional timing variations. Based on an initial placement of devices for an integrated circuit chip, regional variations in one or more physical conditions that impact device timing (e.g., polysilicon perimeter density, average distance of devices to a well edge, average reflectivity) are mapped. Then, using a table that associates different derating factors with different levels of the physical condition(s), derating factors are assigned to different regions on the map. Next, a timing analysis is performed such that, for each region, delay of any path within that region is derated by the assigned derating factor. The map information can also be used when establishing a final placement of the devices on the integrated circuit chip in order to optimize placement of critical paths.

### BACKGROUND

The embodiments of the invention generally relate to integrated circuit chip design and, more particularly, to a design system and an associated method that, during timing analysis, compensates for regional timing variations.

### SUMMARY

Disclosed herein are embodiments of a design system and an associated method that allow for compensation of regional timing variations during timing analysis and, optionally, that allow for optimize placement of critical paths, as a function of such regional timing variations. More particularly, based on an initial placement of devices on an integrated circuit chip, timing variations between different regions of an integrated circuit chip are mapped as a function of regional variations in one or more physical conditions that impact device timing (e.g., polysilicon perimeter density, average distance of devices to a well edge, average reflectivity, etc.). Then, using a table that associates different derating factors with different levels of the physical condition(s), derating factors are assigned to the mapped regions. Next, a timing analysis is performed such that, for each region, delay of any path within that region is derated by the assigned derating factor. Additionally, information about the regional variations in the physical condition(s) and, thereby about regional timing variations can also be used when establishing a final placement of the devices on the integrated circuit chip in order to optimize placement of critical paths.

More particularly, disclosed herein are embodiments of a design system. This design system can comprise at least a data storage device, a placement tool, a map generator, a derating factor assignment tool, and a timing analysis tool. In these system embodiments, the data storage device can store a table that associates different derating factors with different levels of at least one physical condition. The physical condition(s) can be conditions, such as polysilicon perimeter density, average distance of devices to a well edge, average reflectivity, etc., that have a deterministic impact on device delay time. The placement tool can establish a placement for devices on an integrated circuit chip. Then, the map generator can generate a map of the integrated circuit chip, based on this placement and, more particularly, a map identifying multiple regions of the integrated circuit chip and, for each of the regions, a corresponding level of the physical condition(s). Thus, the map, as generated, indicates regional variations in physical condition(s) and, thereby regional variations in average device delay time. The derating factor assignment tool can use the table to assign derating factors to one or more regions on the map and the assigned derating factors can be fed into the timing analysis tool. The timing analysis tool can perform a timing analysis on the integrated circuit chip in such a way that delay of devices within any region of the integrated circuit chip that was assigned a derating factor is derated by that assigned derating factor.

Optionally, map information indicating regional variations in the physical condition(s) and, thereby indicating regional timing variations can also be fed back into the placement tool. This information can be used to establish, in an iterative placement process, a subsequent placement of the devices on the integrated circuit chip in order to optimize placement of critical paths. Specifically, the placement tool can receive the map information and can identify any mapped regions that contain critical paths. Then, for each region containing a critical path, the placement tool can then determine the physical condition level indicated by the map and whether or not the critical path is optimally placed within a region that exhibits minimal device delay. If the critical path is not optimally place, the placement tool can establish another placement for the devices on the integrated circuit chip, ensuring that the critical path is moved from one region into another in order to facilitate timing closure.

Also disclosed herein are embodiments of a design method. In these method embodiments, a placement for devices on an integrated circuit chip can be established (e.g., by a placement tool). Then, a map of the integrated circuit chip can be generated (e.g., by a map generator), based on this placement. Specifically, this map can identify multiple regions of the integrated circuit chip and, for each of the regions, a corresponding level of a physical condition(s) (e.g., polysilicon perimeter density, average distance of devices to a well edge, average reflectivity and/or any other physical condition having a deterministic impact on a device parameter, such as threshold voltage and/or effective channel length, and thereby a deterministic impact on device delay time). Thus, the map, as generated, indicates regional variations in physical condition(s) indicative of regional variations in device parameter(s) and, thereby regional variations in average device delay time. Next, using the table that associates different derating factors with different levels of the physical condition(s), derating factors can be assigned (e.g., by a derating factor assignment tool) to one or more regions on the map. Then, a timing analysis can performed on the integrated circuit chip (e.g., by a timing analysis tool) and it can be performed in such a way that delay of devices within any region of the integrated circuit chip that was assigned a derating factor is derated by that assigned derating factor.

Optionally, map information indicating regional variations in the physical condition(s) and, thereby indicating regional timing variations can also be fed (e.g., by the map generator) back into the placement tool. This information can be used to establish yet another placement of the devices on the integrated circuit chip in order to optimize placement of critical paths. Specifically, any mapped regions that contain critical paths can be identified (e.g., by the placement tool). Then, for each region containing a critical path, a determination can be made (e.g., by the placement tool) as to the physical condition level indicated by the map and as to whether or not the critical path is optimally placed within a region that exhibits minimal device delay. If the critical path is not optimally place, another placement for the devices on the integrated circuit chip can be established (e.g., by the placement tool) such that the critical path is moved from one region into another in order to facilitate timing closure.

Also disclosed herein are embodiments of a computer program product for integrated circuit chip design. This computer program product can comprise a computer readable storage medium having computer readable program code embodied therewith and this computer readable program code can comprise computer readable program code configured to perform the above-described method of designing an integrated circuit chip.

### BRIEF DESCRIPTION OF THE DRAWINGS

The embodiments of the invention will be better understood from the following detailed description with reference to the drawings, which are not necessarily drawing to scale and in which:

FIG. 1 is a schematic diagram illustrating an embodiment of a design system;

FIG. 2 is an illustration of an exemplary table associating different derating factors with different levels of polysilicon perimeter density;

FIG. 3 is an illustration of an exemplary map showing regional variations in polysilicon perimeter density;

FIG. 4 is an illustration of an exemplary table assigning different derating factors to different regions of a map;

FIG. 5 is a flow diagram illustrating an embodiment of a design method; and

FIG. 6 is a schematic diagram illustrating an exemplary hardware environment that can be used to implement the embodiments of the invention.

### DETAILED DESCRIPTION

The embodiments of the invention and the various features and advantageous details thereof are explained more fully with reference to the non-limiting embodiments that are illustrated in the accompanying drawings and detailed in the following description.

Significant regional timing variations can occur on an integrated circuit chip as a function of chip design. Specifically, regional design variations, such as regional variations in polysilicon perimeter density, in proximity effects and in reflectivity, can result in regional differences in device parameters (e.g., effective channel length, threshold voltage, charge carrier mobility, etc.) and, thereby can result in regional differences in device delay time.

For example, regional differences in polysilicon perimeter density (i.e., regional differences in the sum of the perimeter of the polysilicon shape, such as gate structures) can result in regional differences in the average threshold voltage and/or average effective channel length and, thereby regional differences in average delay time. Specifically, when the polysilicon perimeter density in a given region is relatively high, devices in that region will have relatively thin dielectric spacers. Devices with relatively thin dielectric spacers will have relatively low threshold voltages, will have relatively short effective channel lengths, and will exhibit relatively short delay times. On the other hand, when the polysilicon perimeter density in a given region is relatively low, devices in that region will have relatively thick dielectric spacers. Devices with relatively thick dielectric spacers will have relatively high threshold voltages, will have relatively long effective channel lengths and will exhibit relatively long delay times.

Regional differences in proximity effects can result in regional differences in average threshold voltage and average effective channel length and, thereby regional differences in average delay time. As discussed in detail in U.S. Pat. No. 7,302,376 of Adler et al., issued on Nov. 7, 2007, assigned to International Business Machines Corporation of Armonk, N.Y. and incorporated herein by references, there are several different known proximity effects. One such proximity effect occurs during the formation of implanted well regions using masks. When a well is implanted, ions are implanted vertically and also scatter laterally below the mask. Thus, the well edge is not actually aligned with the mask opening. However, design rules allow for devices to be placed within this affected area and the result is a device with an altered threshold voltage (Vt) and an altered effective channel length as compared to other devices within the well. Thus, devices placed in a region of an integrated circuit chip adjacent to a well edge may have a relatively low threshold voltage, a relatively short effective channel length and may, thereby exhibit a relatively short delay time, as compared to devices placed in region of the integrated circuit chip at the center of a well. Other types of proximity effects may also impact device timing. For example, the proximity of a device to an isolation edge can modify strain, thereby increasing or decreasing charge carrier mobility and causing a corresponding increase or decrease in delay time.

Regional differences in reflectivity can result in regional differences in threshold voltages, sheet resistances, drive currents, leakage currents, etc., and thereby regional differences in average delay time. Specifically, regional differences in reflectivity can result in regional variations in rapid thermal anneal (RTA) temperature (e.g., differences of up to 10° C. or more). Regional variations in the RTA temperatures can result in regional variations in dopant activation, causing regional variations in threshold voltages, sheet resistances, drive currents, leakage currents, etc., and, thereby causing regional variations in delay time.

Typical solutions for such regional timing variations often include global margining to account for the variations. However, development and implementation of such solutions are often costly and time consuming. Therefore, it would be advantageous to provide a design system and an associated method that, during timing analysis, can compensate for regional timing variations.

In view of the foregoing, disclosed herein are embodiments of a design system and an associated method that allow for compensation of regional timing variations during timing analysis and, optionally, that allow for optimize placement of critical paths, as a function of such regional timing variations. More particularly, based on an initial placement of devices on an integrated circuit chip, timing variations between different regions of an integrated circuit chip are mapped as a function of regional variations in one or more physical conditions that impact device timing (e.g., polysilicon perimeter density, average distance of devices to a well edge, average reflectivity, etc.). Then, using a table that associates different derating factors with different levels of the physical condition(s), derating factors are assigned to the mapped regions. Next, a timing analysis is performed such that, for each region, delay of any path within that region is derated by the assigned derating factor. Additionally, information about the regional variations in the physical condition(s) and, thereby about regional timing variations can also be used when establishing a final placement of the devices on the integrated circuit chip in order to optimize placement of critical paths.

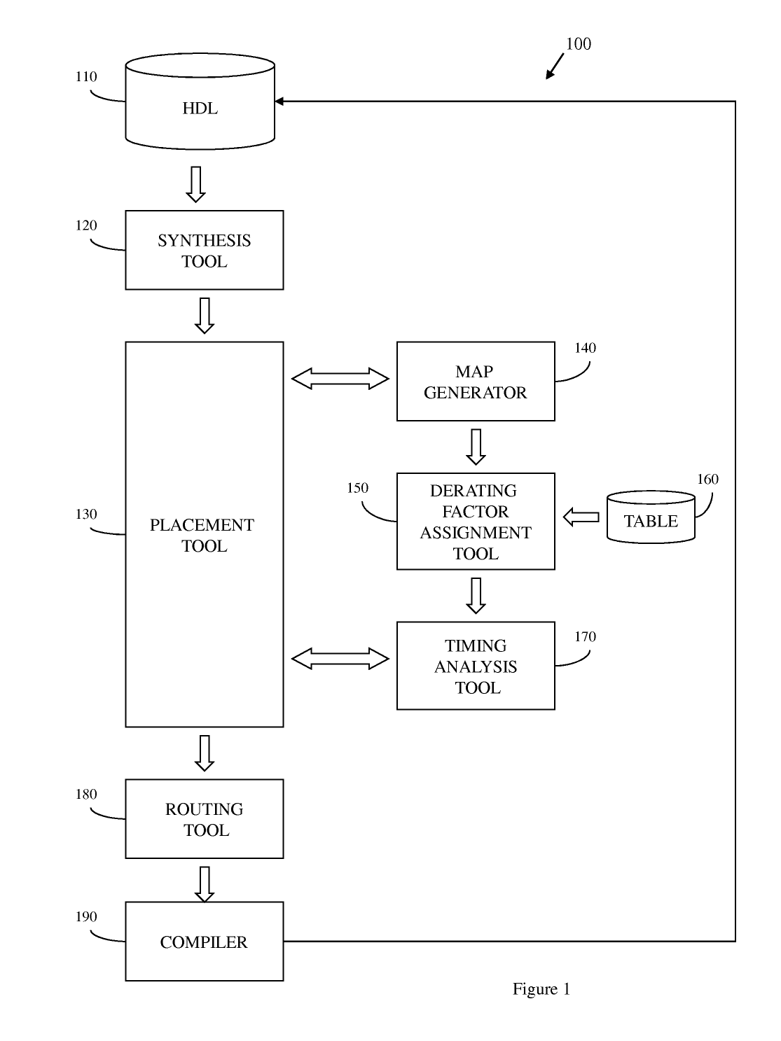

More particularly, referring to FIG. 1, disclosed herein are embodiments of a design system 100. This design system 100 can comprise at least data storage device(s) 110, 160, a synthesis tool 120, a placement tool 130, a map generator 140, a derating factor assignment tool 150, a timing analysis tool 170, a routing tool 180 and a compiler 190.

In these system embodiments, the data storage device 110 can store (i.e., can be adapted to store, configured to store, etc.) a high-level description of an integrated circuit chip design. This high-level description can set out the requirements for the integrated circuit chip using a hardware description language (HDL), such as VHDL or Verilog.

The synthesis tool 120 can comprise a conventional logic synthesis tool (i.e., a synthesis engine). This synthesis tool 120 can access (i.e., can be adapted to access, configured to access, etc.) the data storage device 110 and can synthesize (i.e., can be adapted to synthesize, configured to synthesize, etc.) the high-level description of the integrated circuit chip into a low-level description of the integrated circuit chip (e.g., a gate-level netlist). The details of such synthesis tools are well-known in the art and, thus, are omitted from this specification in order to allow the reader to focus on the salient aspects of the embodiments described herein.

The data storage device 160 can store (i.e., can be adapted to store, configured to store, etc.) a table that associates different derating factors with different levels of at least one physical condition. The physical condition(s) referred to herein can be physical conditions, such as polysilicon perimeter density, average distance of devices to a well edge or other structure (e.g., to an isolation region), average reflectivity, etc., that have a deterministic impact on device parameter(s) (e.g., threshold voltage and/or effective delay) and, thereby a deterministic impact on device delay time. That is, they are known to impact device parameter(s) in a particular manner and, thereby to impact device delay time in a particular manner. In other words, these physical conditions are systematic design-based phenomena that impact device parameters, such as threshold voltage and/or effective channel length, and, thereby impact device delay.

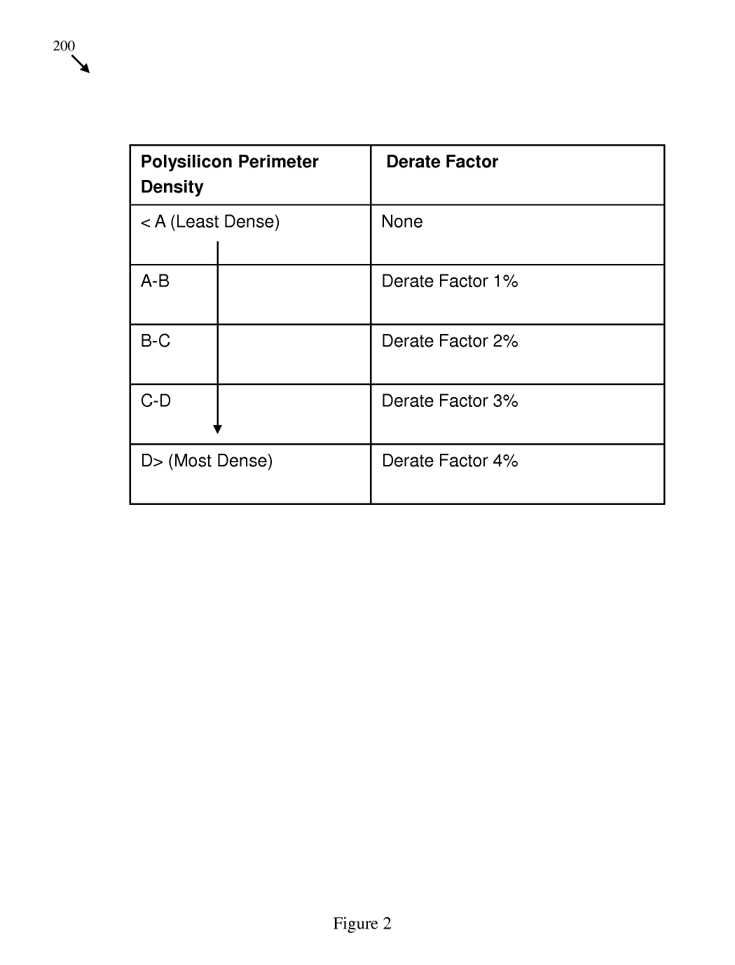

Those skilled in the art will recognize that a derating factor is a factor used during timing analysis to derate delay. For example, a derate factor can be a percentage adjustment applied to the timing of selected path(s) within an integrated circuit so as to make them selectively slower, for purpose of timing analysis, as compared to paths that have not been derated. FIG. 2 illustrates an exemplary derating factor table 200 with derating factors 0%-4% associated with polysilicon perimeter density ranges <A (Least Dense) to D> (Most Dense), respectively, where A-D are predetermined polysilicon perimeter density values.

For illustration purposes, the data storage device 160 storing the derating factors table is shown in FIG. 1 as being a discrete data storage device different from the data storage device 110 storing the high-level description of the integrated circuit chip design. However, it should be understood that, optionally, the data storage device 110 and the data storage device 160 can comprise the same device (i.e., the derating factors table and the hardware description language can be stored on the same data storage device).

The placement tool 130 can establish (i.e., can be adapted to establish, configured to establish, etc.) a placement for devices on an integrated circuit chip or, more particularly, the placement of groups of interconnected devices, referred to as cells or blocks, on an integrated circuit chip. That is, based on the low-level description of the integrated circuit chip (i.e., the gate-level netlist) from the synthesis tool 120, the placement tool 130 can establish an initial placement of cells, which will also include a determination that there will likely be sufficient space available to route single paths between the cells. The details of such placement tools are well-known in the art and, thus, are omitted from this specification in order to allow the reader to focus on the salient aspects of the embodiments described herein.

The map generator 140 can then generate a map of the designed integrated circuit chip, based on this placement and, more particularly, a map identifying multiple regions of the integrated circuit chip and, for each of the regions, a corresponding level of the physical condition(s). Thus, the map, as generated, indicates regional variations in physical condition(s) (e.g., regional variations polysilicon perimeter density, average distance of devices to a well edge or other structure, average reflectivity, and/or any other physical condition having a deterministic impact on one or more device parameters) and, thereby regional variations in average device delay time.

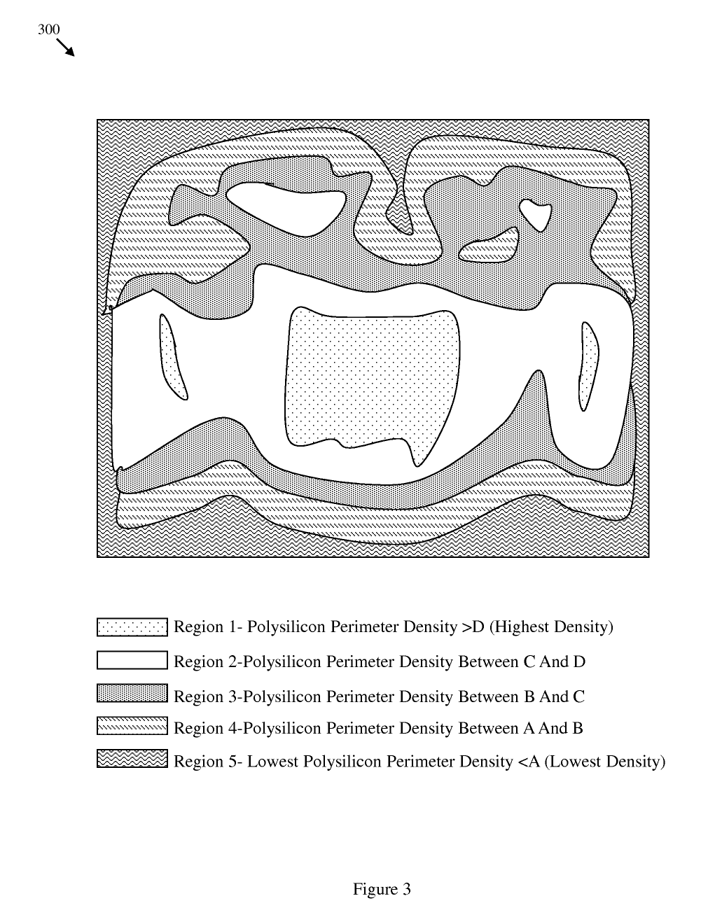

For example, FIG. 3 illustrates an exemplary map 300 of an integrated circuit chip having defined regions 1-5, each with a different polysilicon perimeter density. Region 1 shown in the center of the map 300 has the highest polysilicon perimeter density (i.e., a density greater than D) and region 5 shown at the edges of the map 300 has the lowest polysilicon perimeter density (i.e., a density less than A). As discussed above, when the polysilicon perimeter density in a given region is relatively high, devices in that region will have relatively low threshold voltages and relatively short effective channel lengths and, thereby will exhibit relatively short delay times. On the other hand, when the polysilicon perimeter density in a given region is relatively low, devices in that region will have relatively high threshold voltages and relatively long effective channel lengths, and thereby will exhibit relatively long delay times.

Such a map 300 can be generated, for example, by modeling the design and, in doing so, taking into account one or more of these physical condition(s). The details of mapping individual physical conditions, such as polysilicon perimeter density, proximity to a well edge or other structure and reflectivity, and, thereby mapping region parametric variations (e.g., region threshold voltage and/or regional effective channel length variations), are well-known in the art. Thus, they are omitted from this specification in order to allow the reader to focus on the salient aspects of the embodiments described herein. It should, however, be noted that an exemplary technique that can be used to generate a map showing regional parametric variations based on multiple physical conditions (i.e., multiple systematic design-based phenomena) is disclosed in U.S. patent application Ser. No. 11/876,853, of Culp et al., filed on Oct. 23, 2007, assigned to International Business Machines Corporation, and incorporated herein in its entirety by reference.

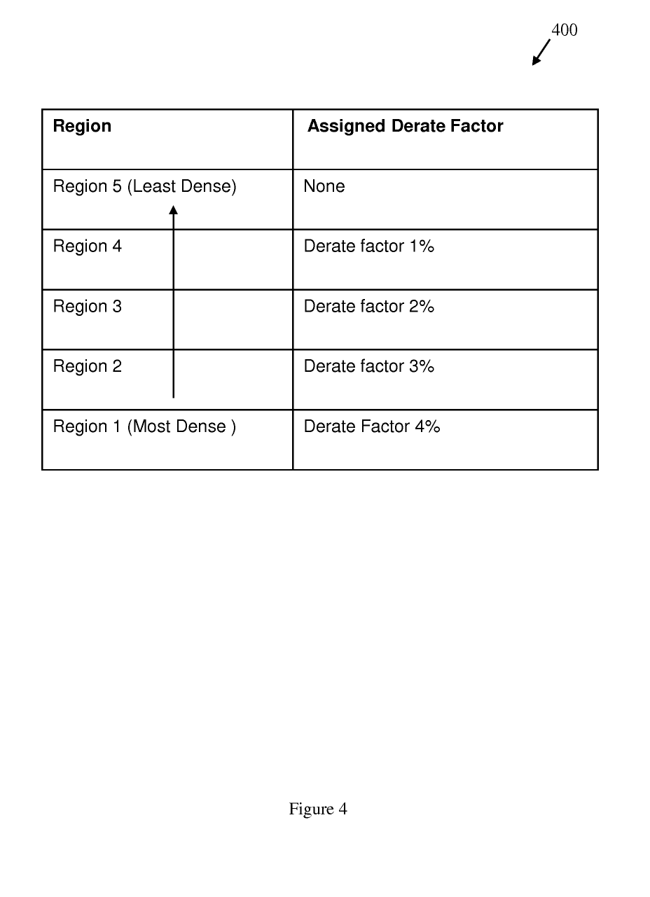

The derating factor assignment tool 150 can use (i.e., can be adapted to use, configured to use, etc.) the derating factor table (e.g., the table 200 of FIG. 2 stored in the data storage device 160) to assign derating factors to one or more of the regions on the map. For example, see the assignment table 400 of FIG. 4 that can be generated by such a derating factor assignment tool 150 based on the regional map 300 of FIG. 3 and the derating factor table 200 of FIG. 2. This assignment table 400 shows a 4% derating factor assigned to the most dense region (i.e., Region 1), a 3% derating factor assigned to Region 2, a 2% derating factor assigned to Region 3, a 1% derating factor assigned to Region 4 and no derating factor assigned to the least dense region (i.e., Region 5). These assigned derating factors can then be fed into the timing analysis tool 170.

The timing analysis tool 170 can perform (i.e., can be adapted to perform, configured to perform etc.) a timing analysis on the integrated circuit chip. Specifically, the timing analysis tool 170 can comprise static timing analysis tool that verifies circuit logic and timing at one or more specific timing corners. However, in the case of the timing analysis tool 170 disclosed herein, static timing analysis is performed in such a way that delay of devices or, more particularly, delay of all paths within any region of the integrated circuit chip that was assigned a particular derating factor is derated by that assigned derating factor. That is, the assigned derating factor can be applied as a percentage adjustment to the timing of all path(s) within the region so as to make those paths selectively slower or faster, for purpose of timing analysis, as compared to paths in other regions subject to smaller derating factors or greater derating factors, respectively. Thus, during the timing analysis, the timing analysis tool 170 compensates for regional variations in device delay times, as a function of regional variations in physical conditions(s) (i.e., systematic design-based phenomena).

It should be noted that the present invention does not preclude derating of specific paths within the regions by some other additional derating factor, as deemed necessary. For example, additional path-specific derating factors maybe assigned to increase path timing to prevent set up fails or decrease path time to prevent hold fails. The details of static timing analysis tools are well-known in the art and, thus, are omitted from this specification in order to allow the reader to focus on the salient aspects of the embodiments described herein.

Optionally, map information indicating regional variations in the physical condition(s) and, thereby indicating regional timing variations can also be fed back into the placement tool 130. This information can be used to establish, in an iterative placement process, a subsequent placement of the devices on the integrated circuit chip in order to optimize placement of critical paths. Specifically, the placement tool 130 can receive the map information and can identify any mapped regions that contain paths that have been designated (e.g., in the design description) as critical paths. Then, for each region containing a critical path, the placement tool 130 can then determine the physical condition level indicated by the map and whether or not the critical path is optimally placed within a region that exhibits minimal device delay. If the critical path is not optimally place, the placement tool 130 can establish another placement for the devices on the integrated circuit chip, ensuring that the critical path is moved from one region into another in order to facilitate timing closure. For example, referring to the map 300 of FIG. 3, if a critical path is determined to be located in Region 5, which has the lowest polysilicon perimeter density and, thereby the greatest average device delay time, a subsequent placement (i.e., a second placement) can be established that moves the cell containing that critical path into Region 1, which has the highest polysilicon perimeter density and thereby the lowest average device delay time. Thus, the placement tool, map generator, and timing analysis tool can function iteratively with multiple placements being established, maps being generated and timing analyses being performed until a final placement is established with optimally placed critical paths and timing closure is achieved.

Next, the routing tool 180 can develop (i.e., can be adapted to develop, configured to develop, etc.) a detailed routing for the integrated circuit chip. This detailed routing defines the wires that will interconnect the cells. The details of routing tools are well-known in the art and, thus, are omitted from this specification in order to allow the reader to focus on the salient aspects of the embodiments described herein.

Finally, the compiler 190 can compile (i.e., can be adapted to compile, configured to compile, etc.) the final results from the placement tool 130, timing analysis tool 170 and routing tool 180 in order to generate a final design structure that will reside on a storage medium (e.g., 110) or programmable gate array in a data format used for the exchange of data of mechanical devices and structures (e.g. information stored in a IGES, DXF, Parasolid XT, JT, DRG, or any other suitable format for storing or rendering such mechanical design structures). This final design structure will preferably comprise one or more files, data structures, or other computer-encoded data or instructions that reside on transmission or data storage media and that when processed by an ECAD system generate a logically or otherwise functionally equivalent form of the designed integrated circuit chip. In one embodiment, this final design structure may comprise a compiled, executable HDL simulation model that functionally simulates the devices of the integrated circuit chip.

Additionally, the final design structure may be generated such that it employs a data format used for the exchange of layout data of integrated circuits and/or symbolic data format (e.g. information stored in a GDSII (GDS2), GL1, OASIS, map files, or any other suitable format for storing such design data structures). The final design structure may also be generated such that it comprises information such as, for example, symbolic data, map files, test data files, design content files, manufacturing data, layout parameters, wires, levels of metal, vias, shapes, data for routing through the manufacturing line, and any other data required by a manufacturer or other designer/developer to produce the integrated circuit chip. This final design structure may then be output by the compiler 190 so that it can proceed to tape-out, be released to manufacturing, be released to a mask house, be sent to another design house, be sent back to a customer, etc.

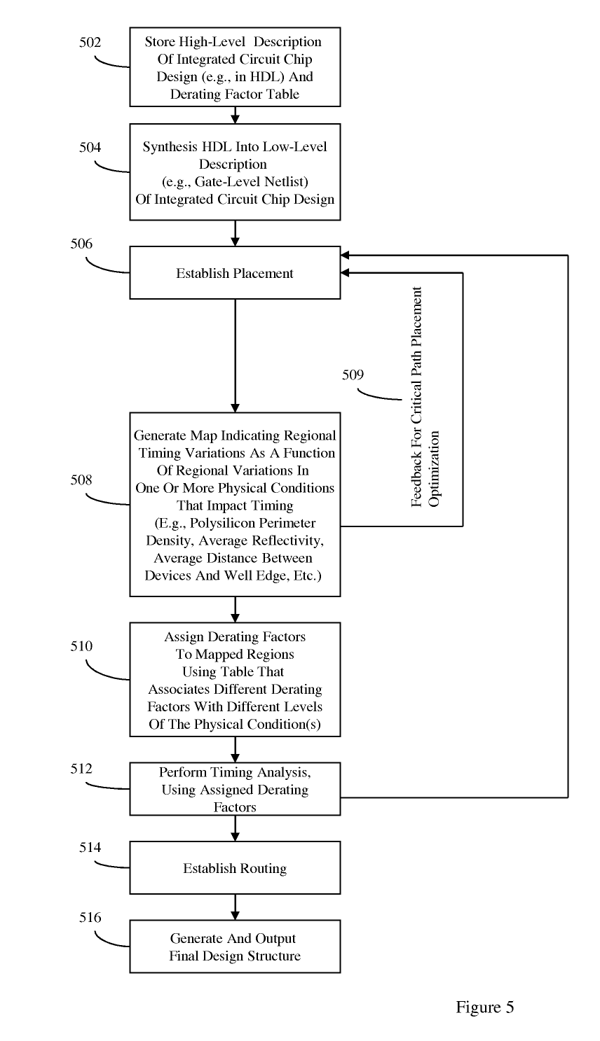

Referring to FIG. 5 in combination with FIG. 1, also disclosed herein are embodiments of an integrated circuit chip design method.

In the method embodiments, a high-level description of an integrated circuit chip design is stored (e.g., on a data storage device 110) (502). This high-level description can set out the requirements for the integrated circuit chip using a hardware description language (HDL), such as VHDL or Verilog.

This high-level description is then accessed (e.g., by a synthesis tool 120) and synthesized into a low-level description of the integrated circuit chip (e.g., a gate-level netlist) (504). The details of such synthesis processes are well-known in the art and, thus, are omitted from this specification in order to allow the reader to focus on the salient aspects of the embodiments described herein.

A table that associates different derating factors with different levels of at least one physical condition is also stored (e.g., by a data storage device 160) (502). The physical condition(s) referred to herein can be physical conditions, such as polysilicon perimeter density, average distance of devices to a well edge or other structure (e.g., to an isolation region), average reflectivity, etc., that have a deterministic impact on device parameter(s) (e.g., threshold voltage and/or effective delay) and, thereby a deterministic impact on device delay time. That is, they are known to impact device parameter(s) in a particular manner and, thereby to impact device delay time in a particular manner. In other words, these physical conditions are systematic design-based phenomena that impact device parameters, such as threshold voltage and/or effective channel length, and, thereby impact device delay. Additionally, those skilled in the art will recognize that a derating factor is a factor used during timing analysis to derate delay. For example, a derate factor can be a percentage adjustment applied to the timing of selected path(s) within an integrated circuit so as to make them selectively slower, for purpose of timing analysis, as compared to paths that have not been derated. FIG. 2 illustrates an exemplary derating factor table 200 with derating factors 0% -4% associated with polysilicon perimeter density ranges <A (Least Dense) to D> (Most Dense), respectively, where A-D are predetermined polysilicon perimeter density values.

Next, a placement can be established (e.g., by a placement tool 130) for devices on the integrated circuit chip or, more particularly, a placement can be established for groups of interconnected devices, referred to as cells or blocks, on an integrated circuit chip (506). That is, based on the low-level description of the integrated circuit chip (i.e., the gate-level netlist), an initial placement of cells can be established, which will also include a determination that there will likely be sufficient space available to route single paths between the cells. The details of such placement processes are well-known in the art and, thus, are omitted from this specification in order to allow the reader to focus on the salient aspects of the embodiments described herein.

Then, a map of the designed integrated circuit chip can be generated (e.g., by a map generator 140) (508). Specifically, this map can be generated based on the placement established at process 506 and can identify multiple regions of the integrated circuit chip and, for each of the regions, a corresponding level of the physical condition(s). Thus, the map, as generated, indicates regional variations in physical condition(s) (e.g., regional variations polysilicon perimeter density, average distance of devices to a well edge or other structure, average reflectivity, and/or any other physical condition having a deterministic impact on one or more device parameters) and, thereby regional variations in average device delay time.

For example, FIG. 3 illustrates an exemplary map 300 of an integrated circuit chip having defined regions 1-5, each with a different polysilicon perimeter density. Region 1 shown in the center of the map 300 has the highest polysilicon perimeter density (i.e., a density greater than D) and region 5 shown at the edges of the map 300 has the lowest polysilicon perimeter density (i.e., a density less than A). As discussed above, when the polysilicon perimeter density in a given region is relatively high, devices in that region will have relatively low threshold voltages and relatively short effective channel lengths and, thereby will exhibit relatively short delay times. On the other hand, when the polysilicon perimeter density in a given region is relatively low, devices in that region will have relatively high threshold voltages and relatively long effective channel lengths, and thereby will exhibit relatively long delay times.

Such a map 300 can be generated at process 508, for example, by modeling the design and, in doing so, taking into account one or more of these physical condition(s). The details of mapping individual physical conditions, such as polysilicon perimeter density, proximity to a well edge or other structure and reflectivity, and, thereby mapping region parametric variations (e.g., region threshold voltage and/or regional effective channel length variations), are well-known in the art. Thus, they are omitted from this specification in order to allow the reader to focus on the salient aspects of the embodiments described herein. It should, however, be noted that an exemplary technique that can be used to generate a map showing regional parametric variations based on multiple physical conditions (i.e., multiple systematic design-based phenomena) is disclosed in U.S. patent application Ser. No. 11/876,853, of Culp et al., filed on Oct. 23, 2007, assigned to International Business Machines Corporation, and incorporated herein in its entirety by reference.

After the map 300 is generated at process 508, a stored derating factor table (e.g., the table 200 of FIG. 2 stored in the data storage device 160) can be used to assign derating factors to one or more of the regions on the map (510). For example, see the assignment table 400 of FIG. 4 that can be generated by such a derating factor assignment tool 150 based on the regional map 300 of FIG. 3 and the derating factor table 200 of FIG. 2. This assignment table 400 shows a 4% derating factor assigned to the most dense region (i.e., Region 1), a 3% derating factor assigned to Region 2, a 2% derating factor assigned to Region 3, a 1% derating factor assigned to Region 4 and no derating factor assigned to the least dense region (i.e., Region 5). These assigned derating factors can then be fed into the timing analysis tool 170.

Once the derating factors are assigned at process 510, a timing analysis can be performed (e.g., by a timing analysis tool 170) on the integrated circuit chip (512). Specifically, the timing analysis process 512 can comprise a static timing analysis process that verifies circuit logic and timing at one or more specific timing corners. This timing analysis process 512 is specifically performed in such a way that delay of devices or, more particularly, delay of all paths within any region of the integrated circuit chip that was assigned a particular derating factor is derated by that assigned derating factor. That is, the assigned derating factor can be applied as a percentage adjustment to the timing of all path(s) within the region so as to make them those paths selectively slower or faster, for purpose of timing analysis, as compared to paths in other regions subject to smaller derating factors or greater derating factors, respectively. Thus, during the timing analysis process 512, regional variations in device delay times, as a function of regional variations in physical conditions(s) (i.e., systematic design-based phenomena), are compensated for.

It should be noted that the present invention does not preclude derating of specific paths within the regions by some other additional derating factor, as deemed necessary. For example, additional path-specific derating factors maybe assigned to increase path timing to prevent set up fails or decrease path time to prevent hold fails. The details of static timing analysis processes are well-known in the art and, thus, are omitted from this specification in order to allow the reader to focus on the salient aspects of the embodiments described herein.

Optionally, in addition to using the map information to compensate for regional variations in device delay during timing, the map information can also be used to optimize placement of critical paths (509). That is, the map information indicating regional variations in the physical condition(s) and, thereby indicating regional timing variations can also be fed back into the placement tool 130. This information can be used to establish, in an iterative placement process, a subsequent placement of the devices on the integrated circuit chip in order to optimize placement of critical paths. Specifically, the map information can be received by the placement tool, which identifies any mapped regions that contain paths that have been designated (e.g., in the design description) as critical paths. Then, for each region containing a critical path, a determination can be made as to the physical condition level indicated by the map and whether or not the critical path is optimally placed within a region that exhibits minimal device delay. If the critical path is not optimally place, another placement for the devices on the integrated circuit chip can be established, ensuring that the critical path is moved from one region into another in order to facilitate timing closure. For example, referring to the map 300 of FIG. 3, if a critical path is determined to be located in Region 5, which has the lowest polysilicon perimeter density and, thereby the greatest average device delay time, a subsequent placement (i.e., a second placement) can be established that moves the cell containing that critical path into Region 1, which has the highest polysilicon perimeter density and thereby the lowest average device delay time. Thus, the processes 506-510 can be performed iteratively, with multiple placements being established, maps being generated and timing analyses being performed until a final placement is established with optimally placed critical paths and timing closure is achieved.

Next, a detailed routing for the integrated circuit chip can be developed (e.g., by a routing tool 180) (514). This detailed routing can be developed such that it defines the wires that will interconnect the cells. The details of routing development processes are well-known in the art and, thus, are omitted from this specification in order to allow the reader to focus on the salient aspects of the embodiments described herein.

Finally, the final results from the process 506-514 can be compiled in order to generate a final design structure (see detailed discussion above) (516).

Also disclosed herein are embodiments of a computer program product for integrated circuit chip design. This computer program product can comprise a computer readable storage medium having computer readable program code embodied therewith and this computer readable program code can comprise computer readable program code configured to perform the above-described method of designing an integrated circuit chip. Specifically, the embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

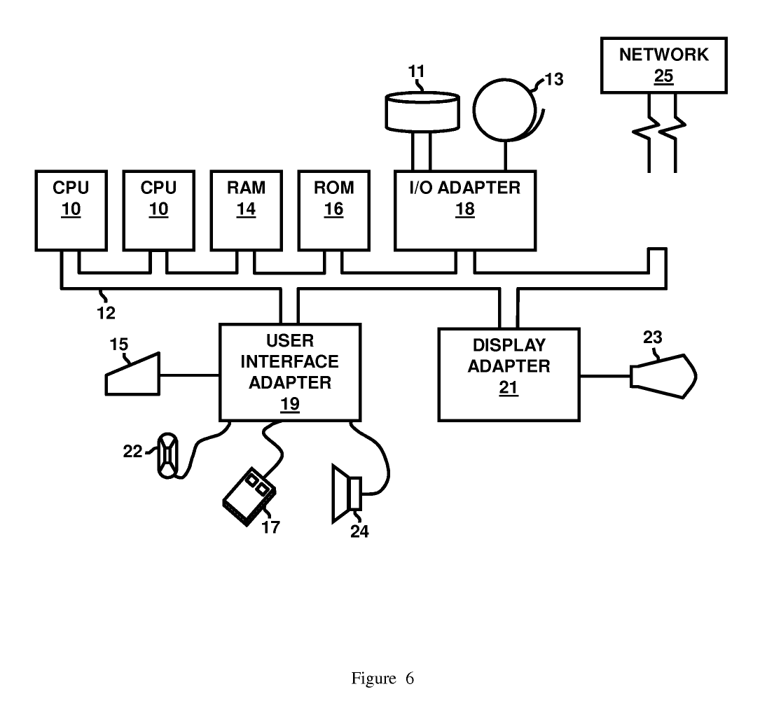

A representative hardware environment for practicing the embodiments of the invention is depicted in FIG. 6. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

It should be understood that the corresponding structures, materials, acts, and equivalents of all means or step plus function elements in the claims below are intended to include any structure, material, or act for performing the function in combination with other claimed elements as specifically claimed. Additionally, it should be understood that the above-description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated. Well-known components and processing techniques are omitted in the above-description so as to not unnecessarily obscure the embodiments of the invention.

Finally, it should also be understood that the terminology used in the above-description is for the purpose of describing particular embodiments only and is not intended to be limiting of the invention. For example, as used herein, the singular forms “a”, “an” and “the” are intended to include the plural forms as well, unless the context clearly indicates otherwise. Furthermore, as used herein, the terms “comprises”, “comprising,” and/or “incorporating” when used in this specification, specify the presence of stated features, integers, steps, operations, elements, and/or components, but do not preclude the presence or addition of one or more other features, integers, steps, operations, elements, components, and/or groups thereof.

Therefore, disclosed above are embodiments of a design system and an associated method that allow for compensation of regional timing variations during timing analysis and, optionally, that allow for optimize placement of critical paths, as a function of such regional timing variations. More particularly, based on an initial placement of devices on an integrated circuit chip, timing variations between different regions of an integrated circuit chip are mapped as a function of regional variations in one or more physical conditions that impact device timing (e.g., polysilicon perimeter density, average distance of devices to a well edge, average reflectivity, etc.). Then, using a table that associates different derating factors with different levels of the physical condition(s), derating factors are assigned to the mapped regions. Next, a timing analysis is performed such that, for each region, delay of any path within that region is derated by the assigned derating factor. Additionally, information about the regional variations in the physical condition(s) and, thereby about regional timing variations can also be used when establishing a final placement of the devices on the integrated circuit chip in order to optimize placement of critical paths.

What is claimed is:

1. A design system comprising:
a data storage device storing a table that associates different derating factors with different levels of at least one physical condition having an impact on device delay time;
a placement tool establishing a placement for devices on an integrated circuit chip;
a map generator in communication with said placement tool and generating a map of said integrated circuit chip based on said placement, said map identifying multiple regions of said integrated circuit chip and, for each of said regions, a level of said at least one physical condition such that said map indicates regional variations in said at least one physical condition and, thereby regional variations in average device delay time;
a derating factor assignment tool in communication with said data storage device and said map generator and using said table to assign a derating factor to at least one of said regions on said map; and
a timing analysis tool in communication with said derating factor assignment tool and performing a timing analysis on said integrated circuit chip such that delay of devices within said at least one of said regions is derated by said derating factor.

2. The system of claim 1, said at least one physical condition comprising polysilicon perimeter density.

3. The system of claim 2, said different derating factors increasing as said polysilicon perimeter density increases.

4. The system of claim 1, said physical condition comprising average distance of devices to a well edge and said different derating factors increasing as said average distance decreases.

5. The system of claim 1, said physical condition comprising reflectivity and said different derating factors increasing as said reflectivity decreases.

6. A design system comprising:
a data storage device storing a table that associates different derating factors with different levels of at least one physical condition having an impact on device delay time;
a placement tool establishing a first placement for devices on an integrated circuit chip;
a map generator in communication with said placement tool and generating a map of said integrated circuit chip based on said first placement, said map identifying multiple regions of said integrated circuit chip and, for each of said regions, a level of said at least one physical condition such that said map indicates regional variations in said at least one physical condition and, thereby regional variations in average device delay time;
a derating factor assignment tool in communication with said data storage device and said map generator and using said table to assign a derating factor to at least one of said regions on said map; and
a timing analysis tool in communication with said derating factor assignment tool and performing a timing analysis on said integrated circuit chip such that delay of devices within said at least one of said regions is derated by said derating factor;
said placement tool in communication with said map generator and further:
identifying any of said regions illustrated in said map that contain critical paths;
determining, for each region identified as containing a critical path, said level of said at least one physical condition; and
establishing a second placement for said devices on said integrated circuit chip, wherein, during said establishing of said second placement, said critical path is moved into a different one of said regions depending upon said level of said at least one physical condition in order to facilitate timing closure.

7. The system of claim 6, said physical condition comprising polysilicon perimeter density.

8. The system of claim 7, said derating factors increasing as said polysilicon perimeter density increases.

9. The system of claim 6, said physical condition comprising average distance of devices to a well edge and said derating factors increasing as said average distance decreases.

10. The system of claim 6, said physical condition comprising reflectivity and said different derating factors increasing as said reflectivity decreases.

11. A design method comprising:
establishing, by a placement tool, a placement for devices on an integrated circuit chip;
generating, by a map generator in communication with said placement tool, a map of said integrated circuit chip based on said placement, said map identifying multiple regions of said integrated circuit chip and, for each of said regions, a level of at least one physical condition having an impact on device delay time such that said map indicates regional variations in said at least one physical condition and, thereby regional variations in average device delay time;
using, by a derating factor assignment tool in communication with said data storage device and said map generator, a table to assign a derating factor to at least one of said regions on said map, said table associating different derating factors with different levels of said at least one physical condition; and
performing, by a timing analysis tool in communication with said derating factor assignment tool, a timing analysis on said integrated circuit chip such that delay of devices within said at least one of said regions is derated by said derating factor.

12. The method of claim 11, said at least one physical condition comprising polysilicon perimeter density.

13. The method of claim 12, said different derating factors increasing as said polysilicon perimeter density increases.

14. The method of claim 11, said physical condition comprising average distance of devices to a well edge and said different derating factors increasing as said average distance decreases.

15. The method of claim 11, said physical condition comprising reflectivity and said different derating factors increasing as said reflectivity decreases.

16. A design method comprising:
establishing, by a placement tool, a first placement for devices on an integrated circuit chip;
generating, by a map generator in communication with said placement tool, a map of said integrated circuit chip based on said first placement, said map identifying multiple regions of said integrated circuit chip and, for each of said regions, a level of at least one physical condition having an impact on device delay time such that said map indicates regional variations in said at least one physical condition and, thereby regional variations in average device delay time;
using, by a derating factor assignment tool in communication with said data storage device and said map generator, a table to assign a derating factor to at least one of said regions on said map, said table associating different derating factors with different levels of said at least one physical condition;
performing, by a timing analysis tool in communication with said derating factor assignment tool, a timing analysis on said integrated circuit chip such that delay of devices within said at least one of said regions is derated by said derating factor,
identifying, by said placement tool, any of said regions illustrated in said map that contain critical paths;
determining, by said placement tool for each region identified as containing a critical path, said level of said at least one physical condition; and
establishing, by said placement tool, a second placement for said devices on said integrated circuit chip, wherein, during said establishing of said second placement, said critical path is moved into a different one of said regions depending upon said level of said at least one physical condition in order to facilitate timing closure.

17. The method of claim 16, said physical condition comprising polysilicon perimeter density.

18. The method of claim 17, said derating factors increasing as said polysilicon perimeter density increases.

19. The method of claim 16, said physical condition comprising average distance of devices to a well edge and said derating factors increasing as said average distance decreases.

20. The method claim 16, said physical condition comprising reflectivity and said different derating factors increasing as said reflectivity decreases.

21. A computer program product for integrated circuit chip design, said computer program product comprising a computer readable storage medium having computer readable program code embodied therewith, said computer readable program code comprising computer readable program code configured to perform a method of designing an integrated circuit chip, said method comprising:
establishing a placement for devices on an integrated circuit chip;
generating a map of said integrated circuit chip based on said placement, said map identifying multiple regions of said integrated circuit chip and, for each of said regions, a level of at least one physical condition having an impact on device delay such that said map indicates regional variations in said at least one physical condition and, thereby regional variations in average device delay time;
assigning a derating factor to at least one of said regions on said map, said assigning comprising using a table that associates different derating factors with different levels of at least one physical condition; and
performing a timing analysis on said integrated circuit chip such that delay of devices within said at least one of said regions is derated by said derating factor.
